(19) United States
(12) Patent Application Publication
(10) Pub. No.: US 2023/0109917 A1
(43) Pub. Date: Apr. 13, 2023

(54) METHOD FOR PREPARING TARGET VALUES FOR A WIND FARM REGULATOR AS WELL AS WIND FARM SERVER AND SYSTEM FOR IT

(71) Applicant: Wobben Properties GmbH, Aurich (DE)

(72) Inventor: Helge Giertz, Leer (DE)

(21) Appl. No.: 17/962,774

(22) Filed: Oct. 10, 2022

(30) Foreign Application Priority Data
Oct. 11, 2021 (EP) 21201880.8

(51) Int. Cl. F03D 7/04; G05B 19/418; H04L 9/40

(52) U.S. Cl. CPC F03D 7/047; G05B 19/41845; H04L 63/083; G05B 2219/25211

(57) ABSTRACT

The invention relates to a method for sending target values to a wind farm regulator of a wind farm via a wind farm server, wherein the wind farm server has an input interface, and the input interface is used to receive target values for the wind farm regulator after a successful authentication by an access data record, wherein one of several predefined user identifiers is allocated in the wind farm server to each of several access data records, which correspond to predefined access data records, wherein the wind farm server is used to allocate the user identifier allocated to the access data record used for successful authentication before receiving the target value to a target value received from the input interface, and received target values with the allocated user identifier are output to the wind farm regulator. The invention further relates to a wind farm server and a system with a wind farm server.

### BACKGROUND

### Technical Field

The invention relates to the area of controlling the wind turbines of a wind farm.

### Description of the Related Art

Individual wind turbines usually have a controller, which is used to control or regulate the operation of these wind turbines. For example, the controller and connected sensors independently detect the prevailing wind conditions, and control or regulate the operation of the wind turbine as a function of these detected wind conditions. If several wind turbines are combined in network to form a wind farm, and thus feed energy into a network at a shared feed point, the control and regulation tasks are partially or completely outsourced to a wind farm regulator as the higher instance for all wind turbines of a wind farm. The controllers of the wind turbines of a wind farm or the wind farm regulator basically enable an essentially autarkic operation of the wind farm.

However, operations management tasks that comprise adjusting the operating behavior of a wind farm from outside of the wind farm are becoming increasingly important in wind farms. This is the result of building permit expenses as well as power and marketing regulations. Accordingly, various different external control systems lying outside of a wind farm must be used to be able to influence the control and regulation of a wind turbine. These operations management tasks are in part also being increasingly implemented automatedly by independent external control systems, in order to satisfy the requirements on an operation.

As a result, wind farm servers are being used ever more frequently in wind farms, wherein the wind farm servers provide a plurality of interfaces which allow various external units to access the wind farm regulator. For example, such interfaces include interfaces for a direct marketer, interfaces for remotely controlling the wind farm, or interfaces for controlling the wind farm by an operator.

These interfaces are each often individually adjusted to the requirements of the external unit that requires access to the wind farm. This results in a plurality of different interfaces of a wind farm server. However, the advantage to usually having a unit dedicated each of the different interfaces is that commands received via the respective interface can be clearly allocated to a unit. A priority is usually allocated to each of the units, and must be considered in the regulator to process the actions on operations management by several units based on their priority. This priority can now be easily derived directly from the knowledge about the interface from which the wind farm server receives data.

Based upon new regulatory changes, for example the introduction of the so-called “Redispatch 2.0,” new specifications are being imposed on renewable energy systems for managing network bottlenecks. This relates to network operators, system operators and direct marketers. In particular, new processes are intended to improve information and data exchange, and to regulate balancing group compensation and billing by implementing predefined redispatch measures. Far-reaching regulations for data exchange between system operators and network operators are becoming necessary. Therefore, a uniform interface for several units must be created, so as to allow various units to access the wind farm via the uniform interface.

Such uniform interfaces are currently not provided, since each unit has so far had its own preferred interface to a wind farm. Adding a new, uniform interface to a wind farm server Involves a difficult retrofit in existing systems, and can most often only be done by changing out the wind farm server and adjusting or renovating the communication structure between the wind farm server and wind farm regulator.

### BRIEF SUMMARY

Provided is a uniform interface is to be created, so as to offer various external units access to a wind farm via the same interface.

Provided is a method for providing target values for a wind farm regulator, which is implemented with the help of a wind farm server having an input interface. The interface is used to receive target values for the wind farm regulator after a successful authentication by an access data record. Accordingly, then, the input interface initially receives one access data record out of several predefined access data records. This is sent to a wind farm server from an external unit, for example a remote computer. For example, the external unit is a computer of a direct marketer or a network operator. For example, this access data record can consist of a username and a password or a predefined character sequence, e.g., even just an IP number. In any event, this access data record clearly identifies a user who is authorized to communicate with the wind farm server. Accordingly, an access data record can lead to a successful authentication if this access data record is stored as a valid access data record in the wind farm server. If the access data record is not stored and thus invalid, an authentication by such an access data record is also unsuccessful. As a consequence, several predefined access data records are known in the wind farm server, which can be used specifically for a successful authentication at the input interface.

Furthermore, one of several predefined user identifications is allocated to each of the access data records in the wind farm server.

In addition, the target value received with the input interface has allocated to it the user identifier, which is allocated to the access data record that was used for successful authentication before receiving the target value. After a successful authentication via an access data record, then, the user identification allocated to the access data record allocated for authentication is allocated to a received target value.

Received target values together with the allocated user identification are then output to the wind farm regulator from the wind farm server.

A user identifier is thus determined from the access data record and allocated to each target value. Various external units that are authorized to transmit target values to the wind farm regulator also receive different access data records. The user identifiers derived from the access data records with the wind farm server and correspondingly allocated to the target values can be used to clearly allocate every target value to the unit that sent this target value. This becomes possible just when various units send their target values to the wind farm server via the same input interface. A wind farm regulator can then use the user identifiers to allocate a priority to the respectively allocated target value.

In summation, then, it is possible to allocate the target values to a source of the target value based upon the user identifier allocated to the target value.

According to a first embodiment, each of the predefined access data records, meaning the access data records that enable a successful authentication, is allocated to a respective first set of the predefined access data records or a second set of the predefined access data records. The same user identifier of several predefined user identifiers is allocated to each of the access data records of the first set in the wind farm regulator. A respective individual user identifier of the several predefined user identifiers is allocated to each of the access data records of the second set.

As a consequence, then, each of the predefined access data records is allocated either to the first set or the second set. Accordingly, user identifiers are individually used only for access data records that are allocated to the second set. All access data records allocated to the first set are allocated to the same user identifier. The resultant advantage is that all access data records that permit a successful authentication, i.e., that are stored in the wind farm server as predefined access data records, can receive access to the wind farm regulator via the transmission of target values. Several of the access data records can be allocated to different user identifiers in order to enable the allocation of target values to access data, i.e., to a unit that sends the target value. Therefore, the invention can be realized with few user identifiers. Accordingly, only a limited number of units allow for an allocation of the target values to the sending unit in the wind farm regulator via the user ID and an allocation of a priority to the target value. This provides for a backward compatibility, so that even those units can transmit target values to the wind farm regulator which, while they do have an access data record, require no identifiable source to process the target values, since they have a standard priority.

Accordingly, an existing system with an interface that has thus far not enabled any allocation and transmission of user identifiers can be adjusted with little effort so as to allocate a user identifier to at least several of the access data records.

According to another embodiment, the wind farm sever comprises at least one additional input interface. The additional input interface is used to receive additional target values for the wind farm regulator, and output these additional target values to the wind farm regulator. Different respective interface identifiers are allocated to the input interface and the additional input interface. In this embodiment, the additional target values are also output with the interface identifier of the additional input interface to the wind farm regulator. As a consequence, each additional target value, i.e., the target value received via the additional input interface, has allocated to it an interface identifier that is transmitted with the target value to the wind farm regulator. For example, target values received from the input interface can also be transmitted with the interface identifier of the input interface to the wind farm regulator. Therefore, all additional target values especially preferably have allocated to them an interface identifier that is transmitted with each of the additional target values, and each of the target values has allocated to it an interface identifier other than the additional target values or alternatively the user identifier transmitted with the target values. For example, a regulator can use the interface identifiers and/or the user identifiers to basically determine the unit that provided the target values. This only applies for a case where only additional target values can be received by a single unit via the additional input interface. Accordingly, if precisely one input interface is open for several units, the additional user identifier allocated to the target value can also be used to identify the unit that transmitted the target value, as already specified previously.

According to another embodiment, the additional target values, specifically the target values received via the additional input interface, are sent to the wind farm regulator without a user identifier. Accordingly, then, only target values received via the input interface are transmitted to the wind farm regulator with a user identifier, and the additional target values of the additional input interface without a user identifier, i.e., user identifier-less. In this way, a data packet transmitted from the wind farm server to the wind farm regulator can especially preferably be designed in terms of data packet size exactly the same for target values received via the input interface as a data packet used to transmit target values received via the additional input interface. A data packet comprising a target value received from the input interface is then transmitted in a data packet with a user identifier, and a target value is transmitted in a data packet with its interface identifier instead of with a user identifier. The regulator can then clearly assign the target values having a user identifier to the input interface, and the target values to which an interface identifier was assigned can be allocated to the additional input interface.

According to another embodiment, a list with several entries is stored in the wind farm server. The number of entries preferably corresponds to the number of predefined user identifications. Each of the entries allocates a respective target value group to each of the predefined user identifications. Each of the target value groups comprises several target values. The target values of one target value group correspond to different types of target values. For example, one type of target value is a target value for regulating an active power. Another type of target value is a target value for regulating a reactive power. In addition, received target values are entered into the target value groups via the input interface based on their allocated user identification and type. Storing the list with several entries here involves saving the list.

As a consequence, all received target values are stored in the wind farm server, thereby making it possible to redundantly store all received target values in the wind farm server in case of a communication error between the wind farm server and wind farm regulator, or in case of a restart of the wind farm regulator. Upon request of the wind farm regulator, the wind part server can retransmit all current target values to the wind farm regulator.

According to another embodiment, a sequence of the entries is updated after a new target value has been received. For example, an entry with a newly received target value is always saved as the last entry in the list, so that the entries are sorted by the time the target values were received. For example, the first entry comprises the target value received furthest in the past, meaning the oldest target value, and the last entry comprises the target value received most recently. During entry in the list, it is here assumed that a target value of a specific kind overwrites a target value of the same kind received beforehand and with the same user ID that was already present in the entry. Accordingly, each target value group that is allocated to a user ID with an entry comprises only one target value of one kind.

Sorting the entries by time received makes it possible to derive an additional prioritization of the target values, for example which the wind farm regulator can used for control purposes.

According to another embodiment, once a new target value has been received with the input interface, the entry with the new target value is transmitted to the regulator. Accordingly, then, not just the target value with its user identification is transmitted to the wind farm regulator, but rather the entire target value group is retransmitted. In this way, the regulator can reprioritize all of the target values in the target value group, and not just the newly received target value, based upon a new reception time that is set for the entire group of target values.

According to another embodiment, all entries are transmitted to the regulator after a request has been received from the wind farm regulator. The entries are preferably sent in their sorted sequence, so that an entry that comprises the target value received furthest in the past is transmitted first, and an entry, in particular the last entry, which comprises the target value received most recently, is transmitted last.

If the wind farm regulator fails or loses the already received target values owing to a restart or the like, the wind farm regulator can be resupplied with all received target values for controlling or regulating the wind turbines. In this way, sorting the transmission of entries by time especially preferably leads to a corresponding sorting in the wind farm regulator, so that the wind farm regulator can carry out a prioritization based on the reception times.

According to another embodiment, each entry comprises an ID that indicates whether the entry was successfully received from the wind farm regulator. After an entry has been sent, the wind farm server updates the ID as a function of a received or missing success message of the wind farm regulator. Accordingly, then, an entry is transmitted from the wind farm server to the wind farm regulator, specifically after a new target value has been received. If the wind farm regulator receives the entry and processes it, this is relayed as a success message from the wind farm regulator to the wind farm server. If the wind farm server receives this success message, the ID is updated, so that it indicates that the entry was successfully received from the wind farm regulator. Given a communication malfunction, then, the success message remains absent, for example after a predetermined period of time has expired. In this way, the ID of the entry indicates that the entry was not received by the wind farm regulator. As a consequence, the entry can be resent either immediately or after a predefined period of time has expired until the success message is received from the wind farm server and the ID is correspondingly adjusted.

It can thus be ensured that the wind farm regulator processes all sent entries.

Provided is a wind farm server for implementing the method according to one of the aforementioned embodiments.

According to an embodiment of the wind farm server, the input interface satisfies an OPC (open platform communications specification). In particular, the input interface satisfies the OPC XML-DA specification, namely an OPC for the XML-based transmission of real-time values. Alternatively, the interface satisfies an IEC 61400 standard, in particular IEC 61400-1:2019. The additional input interface preferably satisfies a specification that differs from the specification of the input interface. An input interface according to the mentioned standards is often already present, and can be easily supplemented by correspondingly adjusting the wind farm server.

Provided is a wind farm server, which is set up to implement the method according to one of the aforementioned embodiments.

According to another embodiment, provided is a system with a wind farm regulator and the wind farm server.

According to an embodiment of the system, the wind farm regulator is set up to control or regulate at least one wind turbine as a function of the target values of the target value groups of the entries.

According to another embodiment of the system, the wind part regulator is set up to allocate a priority to the target values as a function of the user identifier allocated to the target value.

According to another embodiment of the system, the sequence of times at which the entries are received is considered by the wind farm regulator when establishing the priority of a regulation of the wind turbines. Accordingly, a higher priority is allocated to an entry that comprises the target value lying furthest in the past than to an entry that comprises the target value received most recently.

According to another embodiment of the system, a priority of a target value is determined in the wind farm regulator as a function of an interface identifier and/or a user ID of the target value.

### BRIEF DESCRIPTION OF THE SEVERAL VIEWS OF THE DRAWINGS

Additional embodiments may be gleaned from the exemplary embodiments explained in more detail in the figures. Shown on:

FIG. 1 is a wind turbine,

FIG. 2 is a wind farm,

FIG. 3 is a system according to an exemplary embodiment, and

FIG. 4 is a list with entries.

### DETAILED DESCRIPTION

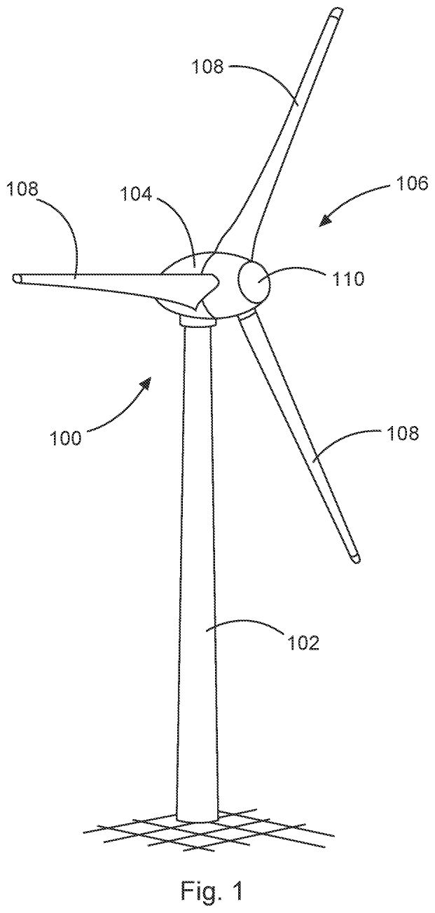

FIG. 1 shows a schematic view of a wind turbine 100 according to the invention. The wind turbine 100 has a tower 102 and a nacelle 104 on the tower 102. An aerodynamic rotor 106 with three rotor blades 108 and a spinner 110 is provided on the nacelle 104. During operation of the wind turbine 100, the aerodynamic rotor 106 is made to rotate by the wind, and thus also turns an electrodynamic rotor or armature of a wind turbine generator, which is directly or indirectly coupled with the aerodynamic rotor 106. The electrical wind turbine generator is arranged in the nacelle 104, and generates electrical energy. The pitch angles of the rotor blades 108 can be changed by pitch motors on the rotor blade roots of the respective rotor blades 108.

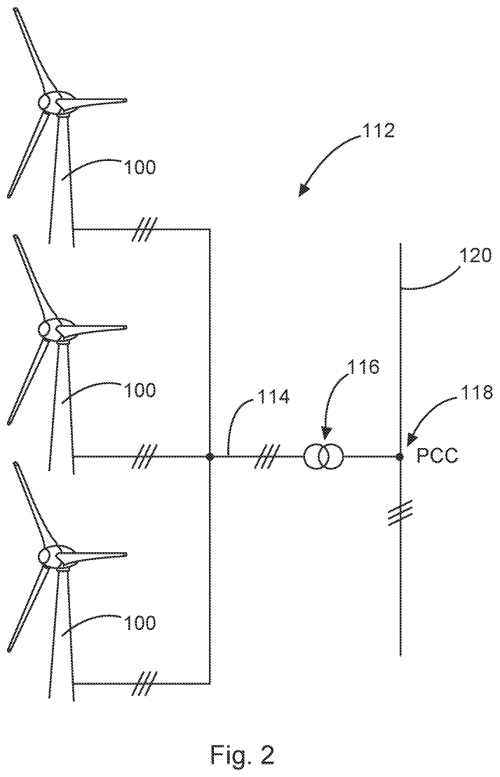

FIG. 2 shows a wind farm 112 with an exemplary three wind turbines 100, which can be identical or different. As a consequence, the three wind turbines 100 are representative for basically any number of wind turbines 100 of a wind farm 112. The wind turbines 100 provide their power, specifically the generated current in particular, via an electrical farm network 114. The respectively generated current or power of the individual wind turbines 100 are here added together, and a transformer 116 is most often provided, which transforms up the voltage in the farm, so as to then feed it into the supply network 120 at the feed point 118, which is also generally referred to as PCC.

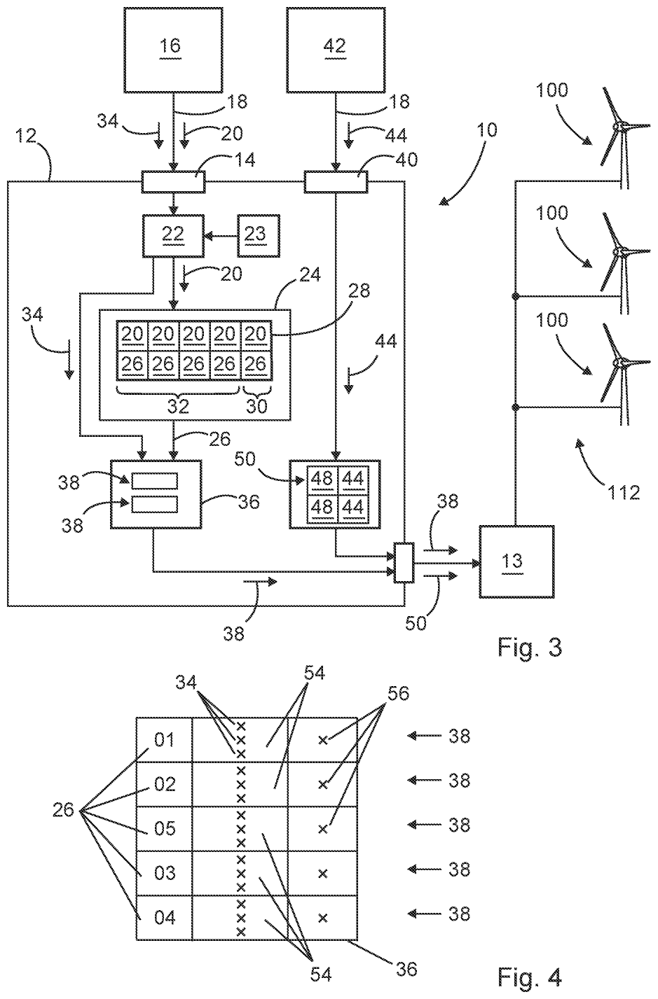

FIG. 3 shows a system 10 according to an exemplary embodiment of the invention. The system 10 comprises a wind farm server 12 and a wind farm regulator 13. The wind farm server 12 has an input interface 14, via which a remote computer 16 receives access to the wind farm server 12 by means of an internet connection 18. To this end, an access data record 20 is sent to the input interface 14 from the remote computer 16. For example, an access data record 20 comprises a username and a password. After received via the input interface 14, the access data record 20 is fed to a user verification unit 22. The access data record 20 is here compared with saved, predefined access data records 23. When a user has been successfully authenticated, the access data record 20 or part of the access data record 20 is transmitted to an allocation unit 24.

In the allocation unit 24, the access data record 20 or a part of the access data record 20 is allocated to a user identifier 26. For example, this takes place based upon a table 28. This means that, if an access data record 20 leads to a successful authentication, a user identifier 26 is determined in the allocation unit 24 as a function of this access data record 20. The access data records 20 with which a user can be successfully authenticated are here each allocated to either a first set 30 or a second set 32. If an access data record 20 is allocated to the second set 32, precisely one user identifier 26 is saved in the allocation unit 24 for each of the access data records 20. If an access data record 20 is allocated to the first set 30, all of the access data records 20 allocated to the first set 30 share the same user identifier 26.

After a successful authentication at the input interface 14, target values 34 for controlling or regulating the wind farm 112 or controlling or regulating the wind turbine 100 of the wind farm 112 can additionally be sent to the wind farm server 12 from the remote computer 16. After successful authentication, these target values 34 are fed to a list 36 together with the user identifier 26, and stored in the list 36. Entries 38 on the list 36 are then transmitted to the wind farm regulator 13, so as to there perform a regulation as a function of the entries 38. Based upon the entries 38, the wind farm regulator can allocate a priority for control or regulation to the received target values 34 as a function of the respectively allocated user identifier 26.

The wind farm server 12 further comprises an additional input interface 40, with which another remote computer 42 can be connected. After authentication, additional target values 44 can likewise be transmitted to the additional input interface 40 via the additional remote computer 42. These additional target values 44 are entered into an additional list 46 together with an interface identifier 48, e.g., PID. The additional entries 50 of the additional list 46 are likewise transmitted to the wind farm regulator 13 for controlling or regulating the wind turbines 100.

FIG. 4 shows the list 36 with its entries 38. Accordingly, an entry 38 is present in each line. The different user identifiers 26 in the respective entry 38 of the list 36 are made in the left column. In the adjacent column, several target values 34 are allocated to a user identifier 26 as target value groups 54 with each entry 38. Furthermore, an ID 56 indicating whether the respective entry 38 has already been successfully transmitted to the wind farm regulator 13 is provided in each entry 38 in the right column.

The additional list 46 is not shown, but according to another exemplary embodiment can look the same as an entry on the list 36, wherein the interface identifier 48 of the additional interface 40 is indicated instead of the user identifiers 26.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving target values at an input interface of a wind farm server, wherein the input interface receives the target values after a successful authentication by an access data record,
wherein one of a plurality of predefined user identifiers is allocated in the wind farm server to each of a plurality of access data records, which correspond to predefined access data records,
wherein the wind farm server is used to allocate the user identifier allocated to the access data record used for successful authentication before receiving the target value to a target value received from the input interface, and
outputting the target values with the allocated user identifier to a wind farm regulator of a wind farm.

2. The method according to claim 1, wherein:
each of the plurality of access data records is allocated to a respective first set of access data records or a second set of access data records in the wind farm server, and a same user identifier of the plurality of predefined user identifiers is allocated to each of the access data records of the first set, and
a respective individual user identifier of the plurality of predefined user identifiers is allocated to each of the access data records of the second set.

3. The method according to claim 1, wherein the wind farm server has an additional input interface, and the additional input interface receives additional target values for the wind farm regulator, and outputs the additional target values to the wind farm regulator, wherein different respective interface identifiers are allocated to the input interface and the additional input interface, and received target values with the interface identifier of the input interface and/or the allocated user identifier and received additional target values with the interface identifier of the additional input interface are output to the wind farm regulator.

4. The method according to claim 3, wherein the additional target values are sent to the wind farm regulator without a user ID.

5. The method according to claim 1, wherein a list with a plurality of entries is saved in the wind farm server, wherein a quantity of the plurality of entries corresponds to a quantity of the plurality of predefined user identifiers, and each of the predefined user identifiers with a respective one of the entries is allocated to precisely one target value group, wherein the target value group comprises several target values, and the target values of a first target value group correspond to different types of target values, and wherein received target values in the target value groups are entered according to their allocated user identification and type.

6. The method according to claim 1, wherein a sequence of entries is updated after a new target value has been received such that an entry with a newly received entry is saved as a last entry so that the sequence of entries are sorted by a time the target values were received such that a first entry comprises the target value received furthest in the past, and a last entry comprises the target value received most recently.

7. The method according to claim 1, wherein after a new target value has been received, the method comprising transmitting an entry with the new target value to the wind farm regulator.

8. The method according to claim 5, wherein all of the entries are transmitted to the wind farm regulator after a request has been received from the wind farm regulator, wherein the plurality of entries are sent in their sequence, so that an entry that comprises the target value received furthest in the past is transmitted first, and the last entry that comprises the target value received most recently is transmitted last.

9. The method according to claim 1, wherein each entry has an ID that indicates whether the entry was successfully received from the wind farm regulator, wherein the ID is updated as a function of a received or missing success message of the wind farm regulator after an entry has been sent.

10. A wind farm server configured to implement the method according to claim 1.

11. The wind farm server according to claim 10, wherein the input interface satisfies an OPC (open platform communications specification), including OPC XML-DA, open platform communications for the XML-based transmission of real-time values, or the input interface is an interface that satisfies an IEC 61400 standard, including IEC 61400-1:2019, and an additional input interface that satisfies a specification that differs from the OPC of the input interface.

12. A system comprising the wind farm server according to claim 10, and a wind farm regulator.

13. The system according to claim 12, wherein the wind farm regulator is configured to regulate a wind turbine of the wind farm as a function of the target values.

14. The system according to claim 12, wherein the wind farm regulator is configured to consider a sequence of times at which entries are received by the wind farm regulator when establishing the priority of a regulation of the wind turbines, such that an entry that comprises the target value lying furthest in the past is used first, and the last entry that comprises the target value received most recently is used last for regulation purposes.

15. The system according to claim 12, wherein the wind farm regulator is configured to allocate a priority to a target value or a target value group as a function of an interface identifier and/or a user identifier that is allocated to the target value or the target value group.
